(19) United States
(12) Patent Application Publication
(10) Pub. No.: US 2009/0307269 A1
(43) Pub. Date: Dec. 10, 2009

(54) Normative database system and method

(76) Inventor: David N. Fernandes, Toronto (CA)

Correspondence Address: Adams and Reese LLP, 1221 McKinney Street, Suite 4400, Houston, TX, 77010, US

(21) Appl. No.: 12/381,004

(22) Filed: Mar. 6, 2009

Related U.S. Application Data
(60) Provisional application No. 61/034,257, filed on Mar. 6, 2008.

(51) Int. Cl. G06F 17/30

(52) U.S. Cl. 707/104.1; 707/E17.044

(57) ABSTRACT

A computerized system and method is provided for managing normative data for metrics and comparing those normative data with metric values for a subject. The normative database provides a means for storing and utilizing normative data from multiple studies and the system automatically determines, or optionally allows a user to determine, which studies will be used in the comparison. The system also optionally allows a user to modify normative data in the normative database or add normative data to the normative database. The system generates images showing the relationship of the metric values to the normative data, optionally utilizing one or more thresholds extracted from the database or provided by the user.

### CROSS-REFERENCE TO RELATED APPLICATIONS

The present application claims the benefit of prior U.S. Provisional Application No. 61/034,257, filed Mar. 6, 2008, which is incorporated herein by reference hereto.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### FIELD OF THE INVENTION

The invention relates to a system and method for managing and utilizing normative data to assess metric values of subjects.

### BACKGROUND OF THE INVENTION

Many fields of endeavor involve the computation or measurement by an investigator of metric values for a subject, such that those metric values can be viewed as samples from a statistical distribution, and require the investigator to compare those metric values against normal values of the metrics to determine how they differ from such normal values. A metric is either a measured value, or is a function that computes a value using one or more measured values, in respect of a subject. Simple examples of a metric are the weight and the weight to height ratio of a subject.

The subject is generally viewed as belonging to a population that is characterized by certain attributes that are relevant to the metric and its intended use. For example, for the metric of weight and the population of humans, the attributes of gender and age may be relevant. A set of values for the chosen attributes defines a segment of the population. Researchers conduct studies that establish norms for metrics for such segments. Such norms define normative data that may include statistical parameters characterizing the distribution of metric values within the segment, ancillary data such as the sample size, and normative thresholds. An upper and a lower normative threshold define a normative range, which includes all metric values less than the upper normative threshold and greater than the lower normative threshold.

The type of normative data that a researcher decides to establish depends on factors such as the nature of the metric, the nature of the distribution of metric values, and the uses to which the normative data are expected to be put. A study will generally establish the same types of normative data for one or more segments of a population. Where, for example, the distribution of metric values in a segment is Gaussian, the normative data for a segment may include: (1) statistical parameters including the calculated mean value and standard deviation based on metric values for a representative sample of subjects from that segment, (2) ancillary data including the sample size, and (3) a set of normative thresholds being equal to the mean value plus or minus certain multiples of the standard deviation. Such normative thresholds may be established by statistical methods, for example so that 95% of the population falls within a normative range. They may also be established by other means such as by use of data showing the implications on human health for metric values being above or below a particular threshold value. It will often be appropriate to define several normative thresholds, such as nominal high and low normative thresholds, metric values between which are considered normal, and stringent upper and lower thresholds, such that metric values exceeding the upper stringent threshold or falling below the lower stringent threshold may indicate the need to take certain actions.

The quality of normative data varies between studies. The perceived quality may vary over time, such as when new research indicates problems with the methodology employed in a particular study, that the population in a study was inadequately segmented, or that a study was otherwise flawed. An investigator may also be aware of aspects of a study that make it more or less suitable for comparison with a set of metric values for a particular subject. For example, it may be important that a prior study used equipment or methods that are similar or comparable to those used in respect of the subject. It may also be desirable to combine one or more of the available studies in order to provide more accurate or representative consolidated normative data for a metric.

Various methods have arisen for comparing metric values with normative data. For example, tables, with attribute values defining the rows and columns, of mean values and normative thresholds may be used to evaluate a metric value to determine if it falls within a normal normative range, or whether it falls within one of several abnormal normative ranges. Such comparisons may be implemented by software that employs a database of norm records, each containing normative data established by a study for a metric, categorized by attributes of the segments. Such a database typically contains one fixed set of normative data for each segment, which generally includes at most one upper and one lower threshold that are considered to define the normal normative range. Such systems may also compute and display the estimated statistical significance of the difference between a subject's metric values and the normative expected metric value. This requires the person who creates the normative database to pre-program normative data to be used for comparison, and typically does not permit an investigator to easily change normative data, or the source studies. Such a system does not allow an investigator to add new norm records to the normative database as they become available, or to select which norms to use in forming the normative database.

Such software systems are typically developed and adapted to a particular type of metric, such as metrics derived from electroencephalography (EEG), and integrated with software that makes and displays values of those particular metrics, as in U.S. Pat. No. ______, which compares EEG metric values with normative values of those metrics and indicates the statistical significance of the degree of deviation from the normative mean values.

The normative database in such systems is typically designed for the specific metrics and populations that the analysis software handles, and the software that compares the metric values to normative data is typically customized for those metrics. The displays are also typically designed only to handle the specific metrics available in the normative database, without allowing an investigator to add new metrics as new studies prove their utility.

There is a need for a normative database that permits a user to quickly and easily add and change norms, and that analyses and displays the measured values against the normative data in an intuitive manner.

### SUMMARY OF THE INVENTION

The invention relates to a normative database system for assessing normality of metric values for at least one metric, the normative database system comprising:
a memory having computer-readable code embodied thereon for execution by a processor, the code comprising
   a set of software instructions for comparing metric values of a subject with normative data from a normative database, and
   a set of software instructions for generating an image suitable for display or recording showing the comparison of metric values with normative data,
      wherein the normative database contains at least one norm record for the at least one metric, from which the normative data are derived. The invention also relates to the normative database system described above where the normative data are consolidated from at least two norm records.

The normative database may further incorporate normative thresholds and the system may allow the user to add new norm records associated with different studies or metrics to the normative database or modify existing norm records in the normative database.

The system may also allow the user to select which of the studies or norm records are available in the norm database, and to select which norm records are used in the derivation of the normative data.

The system may also allow the user to control the form of the display.

### BRIEF DESCRIPTION OF THE FIGURES

FIG. 1 is a block diagram of a preferred embodiment of the system showing the major data flows.

FIG. 2 is a conceptual depiction of the contents of the normative database in a preferred embodiment of the system.

FIG. 3 is an example of an image showing the comparison of metric values with normative data for four metric values for a single subject according to one embodiment.

FIG. 4 is an example of an image showing the comparison of metric values with normative data for multiple sets of metric values taken at different points in time according to another embodiment.

### DETAILED DESCRIPTION

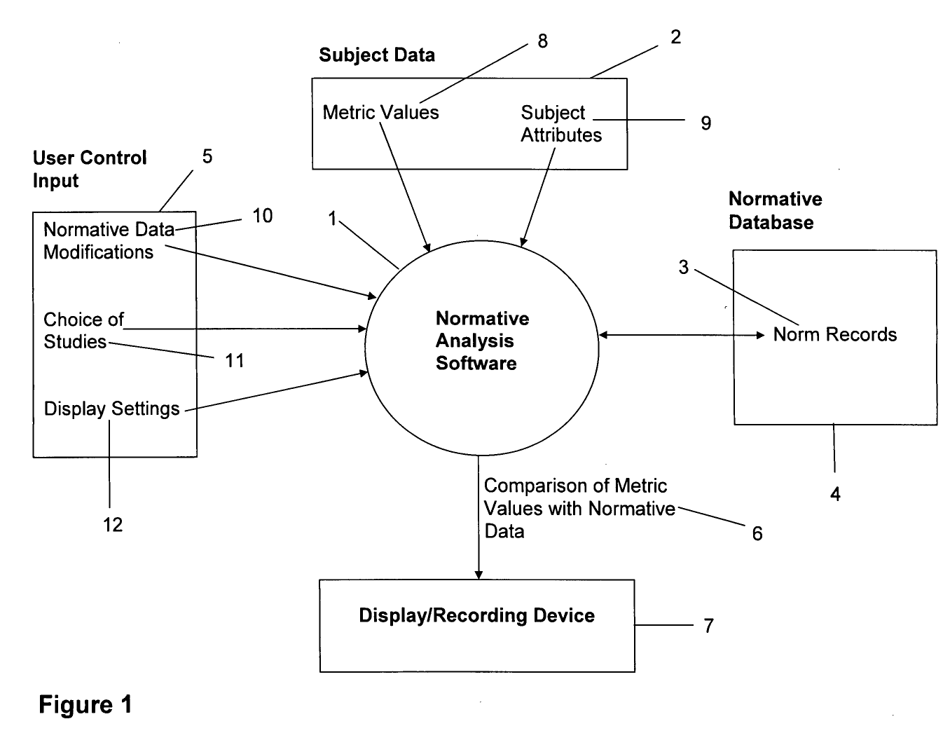

In the preferred embodiment shown in FIG. 1, normative analysis software 1 compares subject data 2, which includes metric values 8, against normative data extracted or derived from norm records 3 contained in a normative database 4. Normative data used for comparison may be single-study normative data extracted from one norm record 3, or may be consolidated from multiple norm records 3 associated with multiple studies. The normative analysis software 1 may employ user control input 5 and may display or record the comparison of metric values with normative data 6 on a display/recording device 7.

Subject data 2 for one or more subjects may be stored and managed in a database (subject DB) independent from the normative database. Subject data 2 may include metric values 8, which may be compared against normative data, and subject attributes 9. The subject DB may include subject data 2 of a particular subject for multiple metrics and may include multiple metric values for the same metric based on measured values corresponding to multiple points in time.

The subject attributes 9 may be used by the normative analysis software 1 to automatically determine, for a metric, which norm records 3 to extract from the normative database 4 to be used to derive consolidated normative data, or to select a single norm record, for use in the comparison as normative data. Alternatively, the user may specify by a choice of studies 11 which norm records 3 to extract from the normative database 4 to form the normative data.

The normative analysis software 1 may combine normative data from multiple norm records 3 to produce normative data based on the nature of the distribution of the metric values, for example, using the statistical parameters and ancillary data contained in the norm records 3. The software 1 may determine which norm records 3 to combine by comparing the norm records 3 using standard statistical procedures, and then combining them into normative data if the norm records 3 are statistically compatible. The software 1 may also calculate consolidated statistical parameters for the normative data.

The normative analysis software 1 may automatically derive normative thresholds for the normative data from the statistical parameters and normative thresholds contained in single-study norm records 3. Alternatively, the normative thresholds may be specified by the user through normative data modifications 10.

One method for automatically deriving the normative thresholds for the normative data is to set the upper threshold of the normative data as the maximum of the single study norm records 3 thresholds, and the lower threshold as the minimum of the single study norm records 3 thresholds. Another method would be to take standard confidence limits, such as the 95% confidence limits, of the normative data based on the consolidated statistical parameters.

From the perspective of the user, the aggregation or integration of more than norm record 3 may be achieved by selecting the desired studies from the user interface provided. The user interface may permit the user to drag and drop the desired studies into the database to be compared to the metric values.

The process of comparing metric values 8 for a subject with normative data may involve receiving metric values 8 for a subject belonging to a segment of a population, where a segment is a subset of the population characterized by attributes relevant to the metric or, where there are no such relevant attributes, the entire population. The next step may be to extract norm records 3 corresponding to the metric and segment from a normative database 4, wherein the norm records 3 include normative data that characterize the distribution of metric values for the segment. If more than one norm record 3 is extracted, the multiple norm records 3 may be combined to produce normative data. The metric values for the subject may then be compared with the normative data, and data may be generated showing the comparison of the metric values with the normative data 6 for output to a display or for recording in a storage element.

The user may provide display settings 12 which are used by the normative analysis software 1 to determine the form of the display of the comparison of metric values with normative data 6.

The system may allow the user to view, modify or add norm records 13 by entering normative data modifications 10.

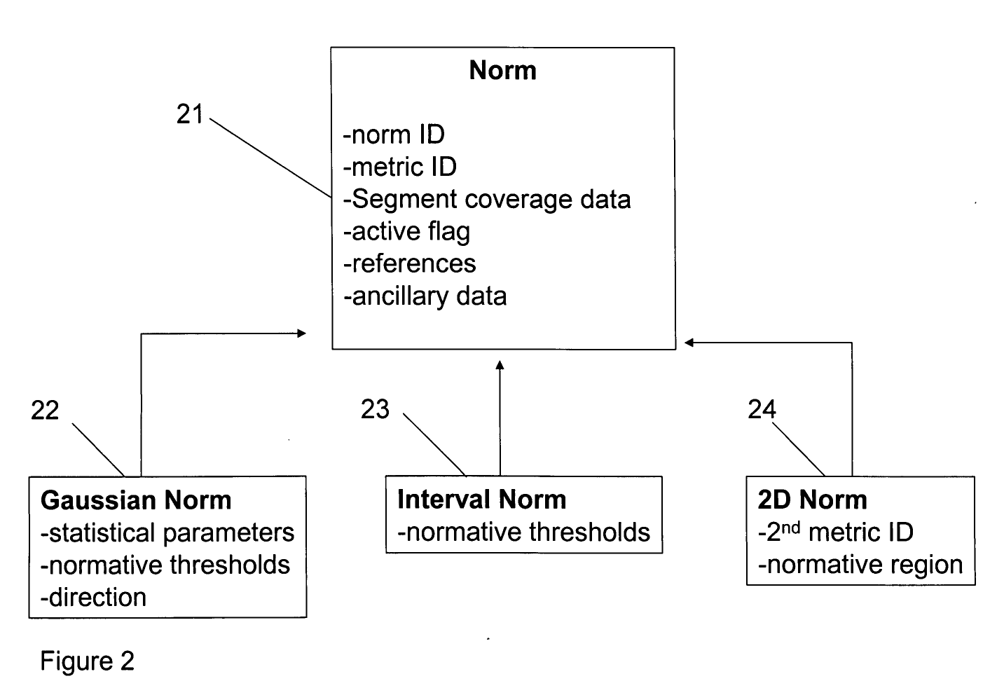

FIG. 2 shows a definition hierarchy for the entities populating the normative database 4, in one embodiment of the invention. The basic norm entity 21 has several attributes common to all norm records. The norm ID uniquely identifies each norm record. The metric ID identifies the metric to which the norm applies. The segment coverage data specify the population segment to which the norm applies. The active flag specifies whether the user wishes to use this norm record 3 in the comparison with metric values. The reference attribute describes the source of the normative data (for example, the publication reference for a study). The ancillary data may provide additional information such as comments and sample size for the study from which the normative data were derived.

Three examples of derived norm subtypes are shown in FIG. 2. Each derived norm subtype 22-24 inherits all attributes from the basic norm entity, and may have some additional attributes. For the Gaussian norm 22, the normative data include statistical parameters, normative thresholds, and a direction flag. Statistical parameters may include the mean and standard deviation of the specified metric for a specific population segment. The normative thresholds are a set of thresholds, in units of standard deviations, that are compared with metric values. The direction flag denotes whether the thresholds apply to values above, below, or both above and below the mean.

The interval norm subtype 23 has normative thresholds that are specified as absolute values. The 2D norm subtype 24 is applied to a pair of metrics. The metric ID inherited from the norm entity together with the second metric ID are used to define a 2-dimensional area. The normative region then specifies the region within this 2-dimensional area that is considered normal, for example by specifying upper and lower normative thresholds for each metric. Derived norm subtypes for multi-dimensional metric spaces may also be included in the normative database.

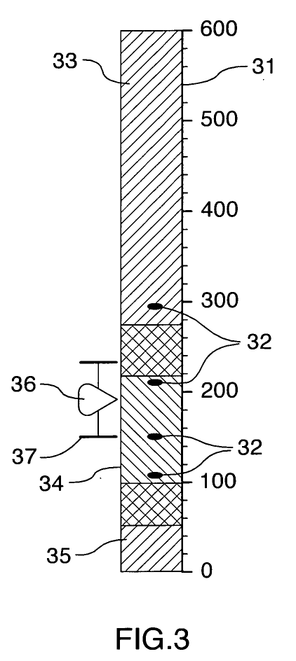

FIG. 3 shows an example of a comparison of metric values with normative data 6 produced by one embodiment of the invention for a single assessment session. The metric axis 31 shows the range over which metric values might fall. Individual metric value marks 32 indicate each metric value for the subject obtained during an assessment session. Colored or otherwise differentially coded bars 33 represent the locations of normative ranges on the metric axis. For example, the color green may be used to represent the range over which a metric value is between the nominal low normative threshold and high normative threshold 34. The color red may be used to represent the ranges over which a metric value is above a high stringent normative threshold 33 or below a low stringent normative threshold 35. The form of the image showing a comparison of metric values with normative data 6 as exemplified by FIG. 3 is not dependent on the metric or its properties.

A summary indicator 36 may be used to show a summary value calculated from the individual metric values. A default setting for each metric or user-entered display settings 12 specify how this summary value is calculated, such as by mean, robust mean, median, maximum or minimum. Limit indicators 37 may be used to show the spread of the metric values. A default setting for each metric or user-entered display settings 12 may specify how this spread is calculated, such as by range, standard deviation, standard error or inter-quartile range of the metric values.

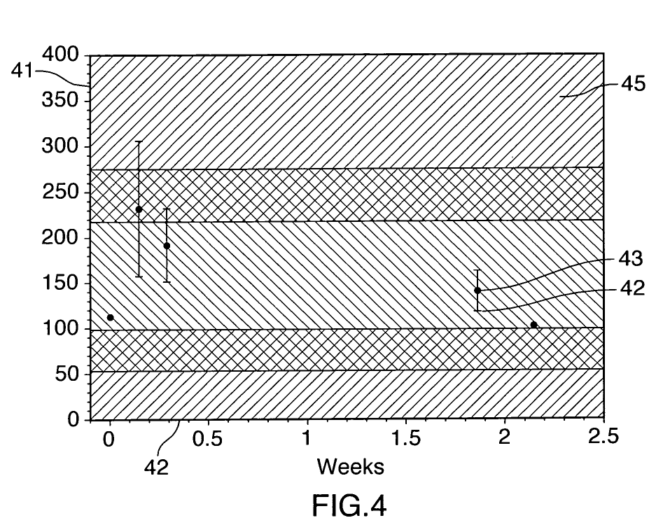

FIG. 4 shows an example of a comparison of metric values with normative data 6 produced by one embodiment of the invention for a series of assessment sessions. The displayed graph plots metric value on the vertical metric axis 41 versus time since initial assessment on the horizontal time axis 42. The axes may have axis ticks to represent numbers corresponding to metric values or time values. In this comparison, individual metric values are not shown. Instead, summary values 43 and limit indicators 44 connected by a line representing the spread are plotted for each assessment session. Colored or otherwise differentially coded regions 45 represent the location of normative ranges on the metric axis 41. The summary values may have been calculated from values of properties of a subject that were measured at the same time, or otherwise having some common characteristic or may be other values identifying the set of metric values.

It will be appreciated that the above description relates to the preferred embodiments by way of example only. Many variations on the system and method for delivering the invention without departing from the spirit of same will be clear to those knowledgeable in the field, and such variations are within the scope of the invention as described and claimed, whether or not expressly described.

What is claimed is:

1. A normative database system for assessing normality of metric values for at least one metric, the normative database system comprising a memory having computer-readable code embodied thereon for execution by a processor, the code comprising:
a set of software instructions for comparing metric values for a subject with normative data from a normative database, wherein the normative database contains at least one norm record for the at least one metric, from which the normative data are derived, and
a set of software instructions for generating an image suitable for display or recording showing the comparison of metric values with normative data.
